(19) United States
(12) Patent Application Publication
(10) Pub. No.: US 2015/0257013 A1
(43) Pub. Date: Sep. 10, 2015

(54) INTER-RADIO ACCESS TECHNOLOGY ADVERTISING IN A MULTI-RADIO ACCESS TECHNOLOGY DEPLOYMENT

(71) Applicant: QUALCOMM Incorporated, San Diego, CA (US)

(72) Inventors: Chirag Sureshbhai PATEL, San Diego, CA (US); Mehmet YAVUZ, San Diego, CA (US); Rajat PRAKASH, San Diego, CA (US)

(73) Assignee: QUALCOMM Incorporated, San Diego, CA (US)

(21) Appl. No.: 14/197,000

(22) Filed: Mar. 4, 2014

(51) Int. Cl. H04W 16/20; H04W 72/04; H04W 28/18

(52) U.S. Cl. CPC H04W 16/20; H04W 28/18; H04W 72/0406

(57) ABSTRACT

Providing inter-radio access technology (RAT) information in a wireless communication network may be achieved by determining, at a first base station operating in accordance with a first RAT, device capability information, system configuration information, or system parameter information for a second RAT different from the first RAT that is implemented by a second base station different from the first base station, and transmitting by the first base station the device capability, system configuration, or system parameter information for the second RAT over a wireless communication channel on the first RAT.

### BACKGROUND

Aspects of this disclosure relate generally to telecommunications, and more particularly to multi-radio access technology (RAT) deployment environments and the like.

Wireless communication systems are widely deployed to provide various types of communication content, such as voice, data, and so on. Typical wireless communication systems are multiple-access systems capable of supporting communication with multiple users by sharing available system resources (e.g., bandwidth, transmit power, etc.). Examples of such multiple-access systems include code division multiple access (CDMA) systems, time division multiple access (TDMA) systems, frequency division multiple access (FDMA) systems, orthogonal frequency division multiple access (OFDMA) systems, and others. These systems are often deployed in conformity with specifications such as third generation partnership project (3GPP), 3GPP long term evolution (LTE), ultra mobile broadband (UMB), evolution data optimized (EV-DO), institute of electrical and electronics engineers (IEEE), etc.

In cellular networks, macro scale base stations (or macro NodeBs (MNBs)) provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience.

To extend cellular coverage indoors, such as for residential homes and office buildings, additional small coverage, typically low power base stations have recently begun to be deployed to supplement conventional macro networks, providing more robust wireless coverage for mobile devices. These small coverage base stations are commonly referred to as femto base stations, femto nodes, femtocells, pico nodes, micro nodes, Home NodeBs or Home eNBs (collectively, H(e)NBs), etc., deployed for incremental capacity growth, richer user experience, in-building or other specific geographic coverage, and so on. Other small coverage base stations may also be deployed to provide wireless communication to various mobile devices, such as wireless local area network (WLAN) access points (APs) operating in accordance with one of the IEEE 802.11x communication protocols (so-called “Wi-Fi” devices). Such small coverage base stations may be connected to the Internet and/or the mobile operator's network via a digital subscriber line (DSL) router or a cable modem, for example.

In mixed radio access technology (RAT) environments (e.g., mixed 3G, 4G, and

Wi-Fi small cell deployments), there is a need to efficiently use the different RATs to optimize overall system capacity and user experience. Typically, however, only the “load” on each RAT is advertised to user devices for system selection purposes. This allows a user device to determine, for example, if its local Wi-Fi is overloaded, and to instead move to a cellular 3G/4G connection, but otherwise provides little or no information about other RATs.

There therefore remains a need for improved inter-RAT information advertising for system selection and load balancing that may provide for more efficient use of user device and network node capabilities.

### SUMMARY

Systems and methods for providing inter-radio access technology (RAT) information in a wireless communication network are disclosed.

A method of providing inter-RAT information in a wireless communication network is disclosed. The method may comprise, for example: determining, at a first base station operating in accordance with a first RAT, device capability information, system configuration information, or system parameter information for a second RAT different from the first RAT that is implemented by a second base station different from the first base station; and transmitting by the first base station the device capability, system configuration, or system parameter information for the second RAT over a wireless communication channel on the first RAT.

An apparatus for providing inter-RAT information in a wireless communication network is also disclosed. The apparatus may comprise, for example, at least one processor and memory coupled to the at least one processor. The at least one processor may be configured to: determine, at a first base station operating in accordance with a first RAT, device capability information, system configuration information, or system parameter information for a second RAT different from the first RAT that is implemented by a second base station different from the first base station, and transmit by the first base station the device capability, system configuration, or system parameter information for the second RAT over a wireless communication channel on the first RAT.

Another apparatus for providing inter-RAT information in a wireless communication network is also disclosed. The apparatus may comprise, for example: means for determining, at a first base station operating in accordance with a first RAT, device capability information, system configuration information, or system parameter information for a second RAT different from the first RAT that is implemented by a second base station different from the first base station; and means for transmitting by the first base station the device capability, system configuration, or system parameter information for the second RAT over a wireless communication channel on the first RAT.

A computer-readable medium comprising code, which, when executed by at least one processor, causes the at least one processor to perform operations for providing inter-RAT information in a wireless communication network is also disclosed. The computer-readable medium may comprise, for example: code for determining, at a first base station operating in accordance with a first RAT, device capability information, system configuration information, or system parameter information for a second RAT different from the first RAT that is implemented by a second base station different from the first base station; and code for transmitting by the first base station the device capability, system configuration, or system parameter information for the second RAT over a wireless communication channel on the first RAT.

### BRIEF DESCRIPTION OF THE DRAWINGS

The accompanying drawings are presented to aid in the description of various aspects of the disclosure and are provided solely for illustration of the aspects and not limitation thereof

FIG. 1 illustrates an example wireless communication network demonstrating the principles of multiple access communication.

FIG. 2 illustrates an example mixed communication network environment in which small cells are deployed in conjunction with macro cells.

FIG. 3 illustrates the configuration of two example small cell base stations for multi-RAT advertising in a multi-RAT deployment environment.

FIG. 4 illustrates an example of a small cell node comprising distinct but physically or logically “co-located” base stations configured for multi-radio access technology (RAT) advertising in a multi-RAT deployment environment.

FIG. 5 is a signaling flow diagram illustrating an example method of providing inter-RAT information in a wireless communication network.

FIG. 6 is a signaling flow diagram illustrating another example method of providing inter-RAT information in a wireless communication network.

FIG. 7 is a flow diagram illustrating an example method for a base station of providing inter-RAT information in a wireless communication network.

FIG. 8 is a flow diagram illustrating an example method for a user device of utilizing inter-RAT information in a wireless communication network.

FIG. 9 illustrates in more detail the principles of wireless communication between wireless devices of a sample communication system.

FIG. 10 illustrates an example base station apparatus represented as a series of interrelated functional modules.

FIG. 11 illustrates an example user device apparatus represented as a series of interrelated functional modules.

### DETAILED DESCRIPTION

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

The techniques described herein provide inter-radio access technology (RAT) information to various user devices in multi-RAT wireless communication network environments. Each base station operating according to its respective RAT may be configured to advertise or otherwise provide to nearby user devices certain information relating to other RATs operating in its vicinity in order to better facilitate system selection by the user devices and load balancing among the individual network devices.

These techniques may be employed in networks that include macro scale coverage (e.g., a large area cellular network such as 3G or 4G networks, typically referred to as a macro cell network) and smaller scale coverage (e.g., a residence-based or building-based network environment, operating in accordance with licensed and/or unlicensed band communication protocols). As a user device moves through such networks, the user device may be served in certain locations by base stations that provide macro coverage and at other locations by base stations that provide smaller scale coverage. As discussed briefly in the background above, the smaller coverage base stations may be used to provide significant capacity growth, in-building coverage, and in some cases different services for a more robust user experience. In the discussion herein, a base station that provides coverage over a relatively large area is usually referred to as a macro base station, while a base station that provides coverage over a relatively small area (e.g., a residence) is usually referred to as a small cell base station, including femto base stations and wireless local area network (WLAN) access points (APs). A cell associated with a macro base station or a small cell base station may be referred to as a macrocell, a small cell, etc. In some system implementations, each cell may be further associated with (e.g., divided into) one or more sectors.

In various applications, it will be appreciated that other terminology may be used to reference a macro base station, a small cell base station, a user device, and other devices, and that the use of such terms is generally not intended to invoke or exclude a particular technology in relation to the aspects described or otherwise facilitated by the description herein. For example, a macro base station may be configured or alternatively referred to as a macro node, NodeB, evolved NodeB (eNodeB), macrocell, and so on. A femto base station may be configured or alternatively referred to as a femto node, Home NodeB, Home eNodeB, femtocell, and so on. A WLAN AP may be configured or alternatively referred to as a WLAN base station, a Wi-Fi AP, an 802.11 AP, and so on. A user device may be configured or alternatively referred to as a device, user equipment (UE), subscriber unit, subscriber station (STA), mobile station, mobile device, access terminal, and so on. For convenience, the disclosure herein will tend to describe various functionalities in the context of generic “base stations” and “user devices,” which, unless otherwise indicated by the particular context of the description, are intended to cover the corresponding technology and terminology in all wireless systems.

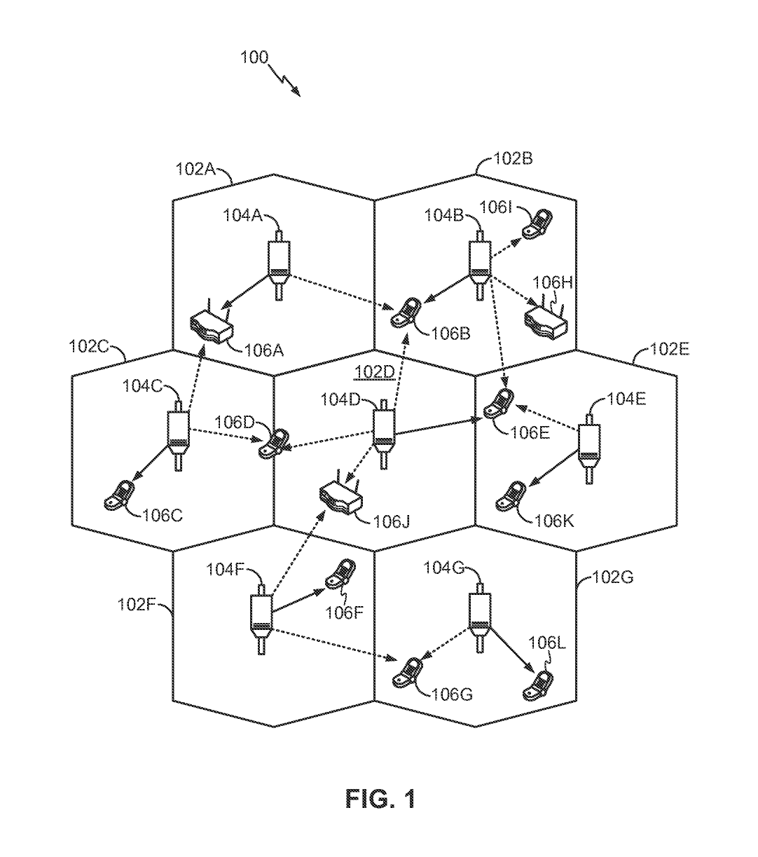

FIG. 1 illustrates an example wireless communication network demonstrating the principles of multiple access communication. The illustrated wireless communication network 100 is configured to support communication between a number of users. As shown, the wireless communication network 100 may be divided into one or more cells 102, such as the illustrated cells 102A-102G. Communication coverage in cells 102A-102G may be provided by one or more base stations 104, such as the illustrated base stations 104A-104G. In this way, each base station 104 may provide communication coverage to a corresponding cell 102. The base station 104 may interact with a plurality of user devices 106, such as the illustrated user devices 106A-106L.

Each user device 106 may communicate with one or more of the base stations 104 on a downlink (DL) and/or an uplink (UL). In general, a DL is a communication link from a base station to a user device, while an UL is a communication link from a user device to a base station. The base stations 104 may be interconnected by appropriate wired or wireless interfaces allowing them to communicate with each other and/or other network equipment. Accordingly, each user device 106 may also communicate with another user device 106 through one or more of the base stations 104. For example, the user device 106J may communicate with the user device 106H in the following manner: the user device 106J may communicate with the base station 104D, the base station 104D may then communicate with the base station 104B, and the base station 104B may then communicate with the user device 106H, allowing communication to be established between the user device 106J and the user device 106H.

The wireless communication network 100 may provide service over a large geographic region. For example, the cells 102A-102G may cover a few blocks within a neighborhood or several square miles in a rural environment. As noted above, in some systems, each cell may be further divided into one or more sectors (not shown). In addition, the base stations 104 may provide the user devices 106 access within their respective coverage areas to other communication networks, such as the Internet or another cellular network. As further mentioned above, each user device 106 may be a wireless communication device (e.g., a mobile phone, router, personal computer, server, etc.) used by a user to send and receive voice or data over a communications network, and may be alternatively referred to as an access terminal (AT), a mobile station (MS), a user equipment (UE), etc. In the example shown in FIG. 1, the user devices 106A, 106H, and 106J comprise routers, while the user devices 106B-106G, 106I, 106K, and 106L comprise mobile phones. Again, however, each of the user devices 106A-106L may comprise any suitable communication device.

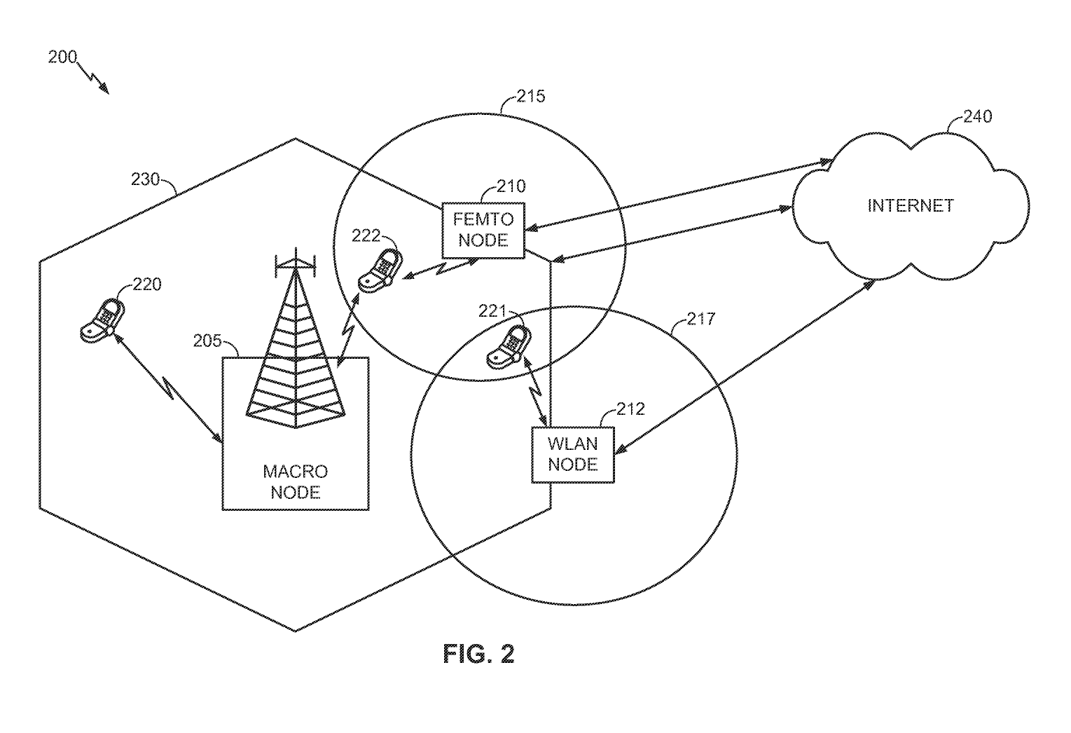

FIG. 2 illustrates an example mixed communication network environment in which small cells are deployed in conjunction with macro cells. Here, a macro base station 205 may provide communication coverage to one or more user devices, such as the illustrated user devices 220, 221, and 222, within a macro area 230, while small cell base stations 210, 212 may provide their own communication coverage within respective small cell areas 215 and 217, with varying degrees of overlap among the different coverage areas. In this example and for illustration purposes, the small cell base station 210 is shown as a femto base station providing cellular coverage while the small cell base station 212 is shown as a WLAN AP providing Wi-Fi coverage. Further, at least some user devices, such as the illustrated user device 222, may be capable of operating both in macro environments (e.g., macro areas) and in smaller scale network environments (e.g., residential, femto areas, pico areas, etc.). It will be appreciated that certain small cell nodes may be restricted in some manner, such as for association and/or registration, and that certain small cells may therefore be alternatively referred to as Closed Subscriber Group (“CSG”) cells.

In the connections shown, the user device 220 may generate and transmit a message via a wireless link to the macro base station 205, the message including information related to various types of communication (e.g., voice, data, multimedia services, etc.). The user device 222 may similarly communicate with the femto base station 210 via a wireless link, and the user device 221 may similarly communicate with the WLAN AP 212 via a wireless link. The macro base station 205 may also communicate with a corresponding wide area or external network 240 (e.g., the Internet), via a wired link or via a wireless link, while the small cell base stations 210 and 212 may also similarly communicate with the network 240, via their own wired or wireless links. For example, the small cell base stations 210 and 212 may communicate with the network 240 by way of an Internet Protocol (IP) connection, such as via a digital subscriber line (DSL, e.g., including asymmetric DSL (ADSL), high data rate DSL (HDSL), very high speed DSL (VDSL), etc.), a TV cable carrying IP traffic, a broadband over power line (BPL) connection, an optical fiber (OF) link, or some other link.

The network 240 may comprise any type of electronically connected group of computers and/or devices, including, for example, the following networks: Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 240 includes network variations such as the public Internet, a private network within the Internet, a secure network within the Internet, a private network, a public network, a value-added network, an intranet, and the like. In certain systems, the network 240 may also comprise a virtual private network (VPN).

Accordingly, it will be appreciated that the macro base station 205 and/or either or both of the small cell base stations 210 and 212 may be connected to the network 240 using any of a multitude of devices or methods. These connections may be referred to as the “backbone” or the “backhaul” of the network. Devices such as a radio network controller (RNC), base station controller (BSC), or another device or system (not shown) may be used to manage communications between two or more macro base stations, small cell base stations, etc. In this way, depending on the current location of the user device 221, for example, the user device 221 may access the communication network 240 by the macro base station 205, by the femto base station 210, or by the WLAN AP 212.

For their respective wireless air interfaces, the macro base station 205 and the small cell base stations 210, 212 may operate according to one of several RATs depending on the network in which they are deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2).

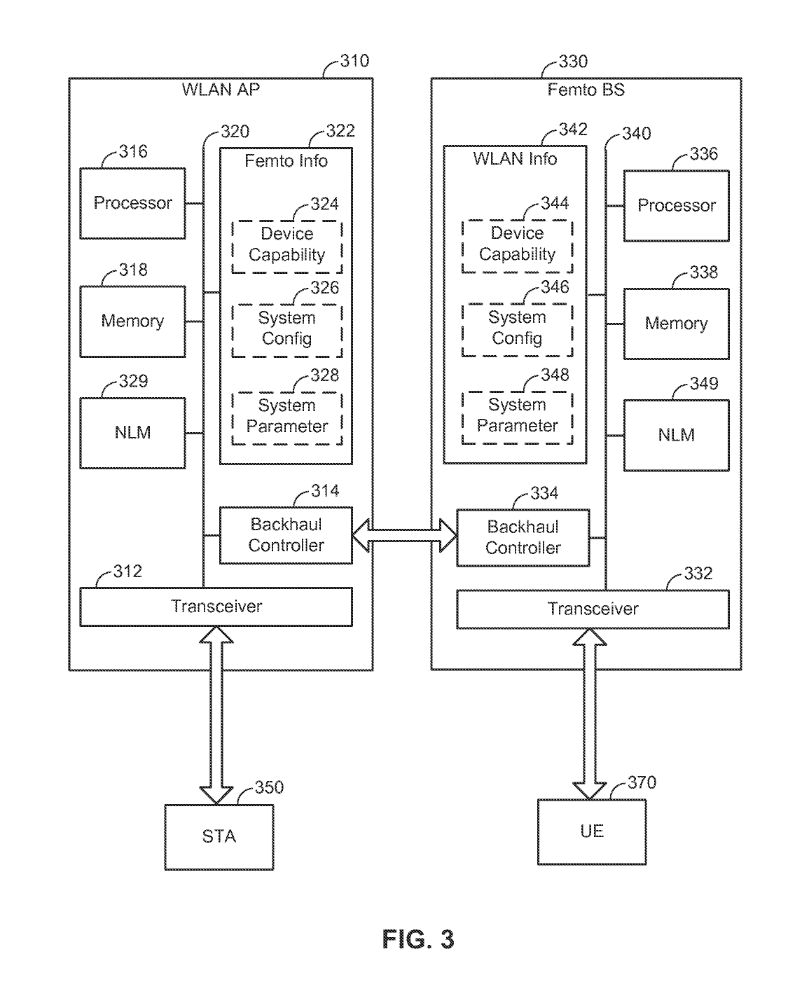

FIG. 3 illustrates the configuration of two example small cell base stations for multi-RAT advertising in a multi-RAT deployment environment. In this example, a WLAN AP 310 is deployed remote from but in the vicinity of a femto base station 330. The WLAN AP 310 may serve one or more STAs 350 (e.g., in accordance with an IEEE 802.11x protocol) and the femto base station 330 may serve one or more UEs 370 (e.g., in accordance with a 3G/4G cellular communication protocol). The STAs 350 and the UEs 370 are shown in the singular for illustration purposes, but may include any number of user devices.

In general, the WLAN AP 310 and the femto base station 330 each include various components for providing and processing services related to over-the-air and backhaul connectivity. For example, the WLAN AP 310 may include a transceiver 312 for over-the-air communication with the STAs 350 and a backhaul controller 314 for backhaul communications with the femto base station 330 as well as other network devices. These components may operate under the direction of a processor 316 in conjunction with memory 318, for example, all of which may be interconnected via a bus 320 or the like. Similarly, the femto base station 330 may include a transceiver 332 for over-the-air communication with the UEs 370 and a backhaul controller 334 for backhaul communications with the WLAN AP 310 as well as other network devices. These components may operate under the direction of a processor 336 in conjunction with memory 338, for example, all of which may be interconnected via a bus 340 or the like.

In addition, the WLAN AP 310 further includes femto information 322 relating to the femto base station 330, and the femto base station 330 similarly includes WLAN information 342 relating to the WLAN AP 310. As shown, the femto information 322 may include device capability information 324 relating to the 3G/4G cellular RAT implemented by the femto base station 330, system configuration information 326 relating to the 3G/4G cellular RAT implemented by the femto base station 330, and/or system parameter information 328 relating to the 3G/4G cellular RAT implemented by the femto base station 330. Conversely, the WLAN information 342 may include device capability information 344 relating to the WLAN RAT implemented by the WLAN AP 310, system configuration information 346 relating to the WLAN RAT implemented by the WLAN AP 310, and/or system parameter information 348 relating to the WLAN RAT implemented by the WLAN AP 310. This inter-RAT information may be advertised or otherwise provided to nearby user devices such as the STAs 350 and UEs 370 in order to better facilitate system selection by the user devices and load balancing among the individual network devices.

By way of example, the device capability information may include information concerning multiple-input and multiple-output (MIMO) capabilities, carrier aggregation (CA) capabilities, power amplifier (PA) capabilities, standard version(s) supported (e.g., LTE Rel. 8, Rel. 9, Rel. 10), etc. For example, the WLAN AP 310 may advertise different 3G/4G cellular capabilities of the femto base station 330, such as MIMO and CA, that may be preferable to one of the STAs 350. The system configuration information may include supported modes of operation such as Wi-Fi a/b/n, bandwidth utilization, transmit (Tx) power utilization, etc. For example, one of the UEs 370 that supports Wi-Fi but only 802.11a Wi-Fi may be provided with information by the femto base station 330 to search for other specifically 802.11a Wi-Fi APs for service, if needed. As another example, if the WLAN AP 310 is operating in a 20 MHz bandwidth only, but the femto base station 330 is operating (e.g., in CA mode) with a 40 MHz bandwidth, a user device made aware of this information may decide to pursue service from the femto base station 330 instead of the WLAN AP 310. The system parameter information may include signal acquisition information such as timing, scrambling codes, access point identifier (e.g., Wi-Fi SSID, femto AP CSG ID), RF operating channel, etc. For example, the WLAN AP 310 may provide the STAs 350 with a pseudorandom noise (PN) offset in use by the femto base station 330 so that a full cell search procedure may be avoided.

The various device capability, system configuration, and system parameter information for the other RATs may be disseminated by the WLAN AP 310 and the femto base station 330 to nearby user devices in different ways. The advertised information may be broadcast, for example, using a control channel. As another example, the advertised information may be sent directly to an attached user device using a dedicated or shared control channel or data channel, such as when the user device is in connected mode (i.e., transmitting/receiving data) or in idle (stand-by) mode. In this way, user devices such as the STAs 350 and UEs 370 may be provided with additional information to assist them in choosing better reselection candidates operating in their vicinity.

The various device capability, system configuration, and system parameter information may also be determined in different ways by the WLAN AP 310 and the femto base station 330, such as via over-the-air sniffing, user device messaging, backhaul-based information exchange, and so on. For example, the WLAN AP 310 and the femto base station 330 may be further provisioned with respective network listen modules (NLMs) 329 and 349, as shown in FIG. 3, or with other suitable components for monitoring communication signaling on other RATs (e.g., on a corresponding carrier frequency) to determine a corresponding channel quality (e.g., received signal strength), broadcasted system information, etc. In addition or alternatively, the WLAN AP 310 and the femto base station 330 may rely on the STAs 350 and UEs 370 to monitor such communication signaling from other RATs (e.g., as dual-mode user devices) or to otherwise receive certain information from one or more base stations operating in accordance with other RATs (e.g., when the user device is camped on or directly connected to those base stations). The user devices may then report back any relevant information. Still further, the WLAN AP 310 and the femto base station 330 may exchange certain information over the backhaul, either directly or through one or more intermediary servers, using their respective backhaul controllers 314, 334, as is further illustrated in FIG. 3.

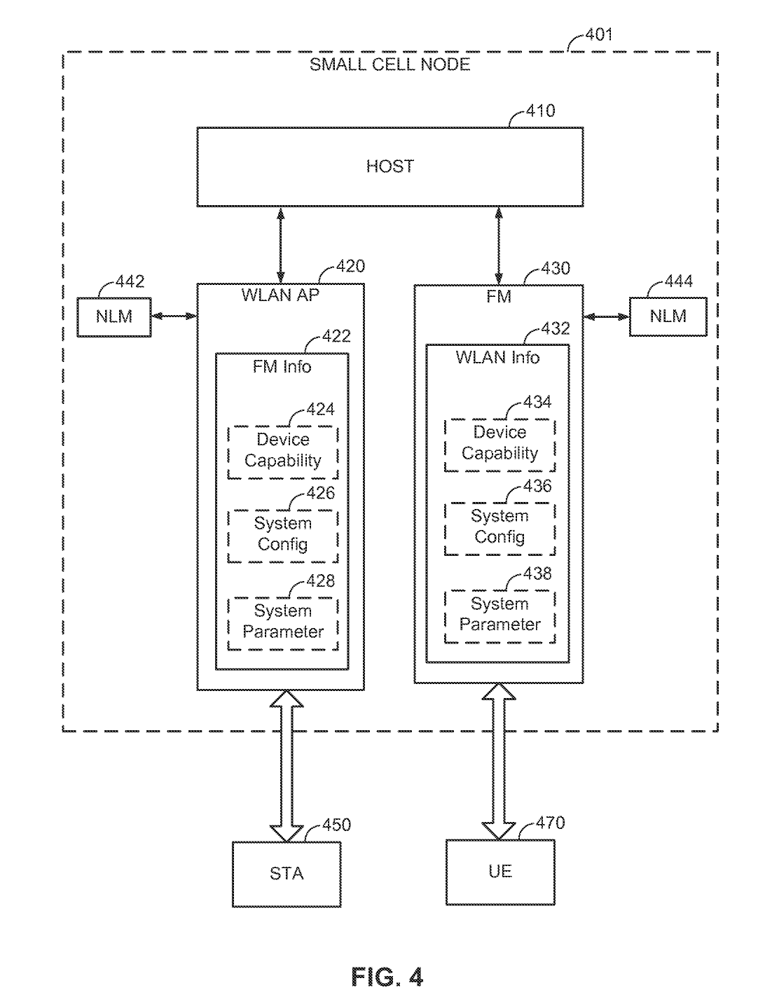

FIG. 4 illustrates an example of a small cell node comprising distinct but physically or logically “co-located” base stations configured for multi-RAT advertising in a multi-RAT deployment environment. In this way, the small cell node 401 may be able to provide both a WLAN air interface (e.g., in accordance with an IEEE 802.11x protocol) and a 3G/4G cellular air interface (e.g., in accordance with an LTE protocol) using respective base stations. For example, the small cell node 401 may include a WLAN AP module 420 co-located with a Femto Modem (FM) 430, as shown, each interfacing with host functionality 410. The host functionality 410 may provide various services related to backhaul connectivity and processing, for example, while the WLAN AP module 420 and FM 430 may each perform base station processing in accordance with their respective RATs to communicate with the STAs 450 and UEs 470 (shown again in the singular for illustration purposes). It will be appreciated that, in some designs, the functionality of one or more of these components may be integrated directly into, or otherwise performed by, a transceiver and one or more general purpose controllers or processors in conjunction with memory (not shown) configured to store related data or instructions, as described in more detail above in relation to FIG. 3.

As with the design of FIG. 3, each base station operating according to its respective RAT may be independently configured to advertise or otherwise provide to nearby user devices certain information relating to other RATs operating in its vicinity in order to better facilitate system selection by the user devices and load balancing among the individual network devices. In this regard, the WLAN AP module 420 similarly includes FM information 422 relating to the FM 430, and the FM 430 similarly includes WLAN information 432 relating to the WLAN AP module 420. As shown and discussed above in more detail, the FM information 422 may include device capability information 424 relating to the 3G/4G cellular RAT implemented by the FM 430, system configuration information 426 relating to the 3G/4G cellular RAT implemented by the FM 430, and/or system parameter information 428 relating to the 3G/4G cellular RAT implemented by the FM 430. Conversely, the WLAN information 432 may include device capability information 434 relating to the WLAN RAT implemented by the WLAN AP module 420, system configuration information 436 relating to the WLAN RAT implemented by the WLAN AP module 420, and/or system parameter information 438 relating to the WLAN RAT implemented by the WLAN AP module 420.

The WLAN AP module 420 and the FM 430 may be configured to transmit their respective FM information 422 and WLAN information 432 to nearby devices (e.g., the STAs 450 and UEs 470) using one or more of their respective wireless communication channels. The various device capability, system configuration, and system parameter information for the different RATs may also be determined in different ways by the WLAN AP module 420 and the FM 430, such as via over-the-air sniffing, user device messaging, backhaul-based information exchange, and so on.

In addition to the example designs of FIGS. 3-4, it will be appreciated that the above description applies equally to still further designs involving other arrangements of a first base station operating in accordance with a first RAT and a second base station operating in accordance with a different second RAT.

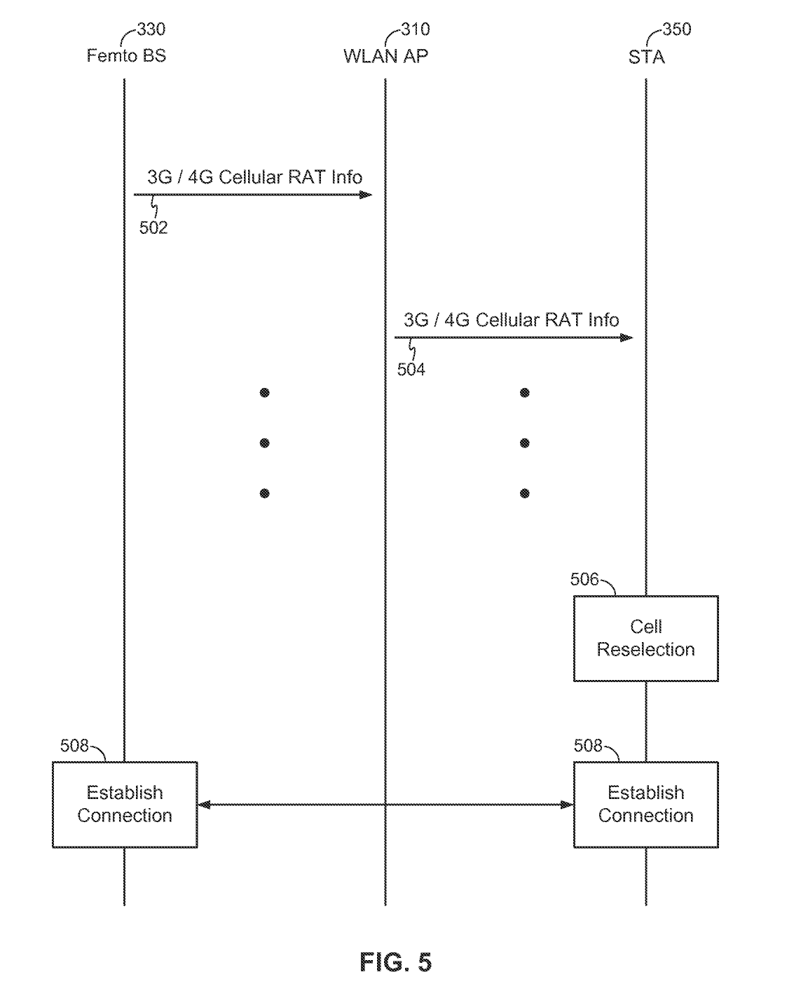

FIG. 5 is a signaling flow diagram illustrating an example method of providing inter-RAT information in a wireless communication network. For generality, the following description of inter-RAT advertising and related aspects is provided in the context of the WLAN AP 310 and femto base station 330 design of FIG. 3. It will be appreciated, however, that this description applies equally to other designs involving a different arrangement of a first base station operating in accordance with a first RAT and a second base station operating in accordance with a different second RAT, such as the co-located WLAN AP module 420 and FM 430 design of FIG. 4 or still other designs.

In this example, the WLAN AP 310 provides one of the STAs 350 with inter-RAT information relating to the femto base station 330, which the STA 350 uses to perform cell reselection and connect to the femto base station 330.

In particular, the WLAN AP 310 initially obtains information relating to the 3G/4G cellular RAT implemented by the femto base station 330 operating in its vicinity (signaling exchange 502). This information may relate to various device capabilities, system configurations, or system parameters for the 3G/4G cellular RAT, and may be determined in different ways by the WLAN AP module 420, such as via over-the-air sniffing or backhaul-based information exchange (as shown), or by user device messaging and so on. The WLAN AP 310 subsequently transmits all or a portion of the obtained information to the STA 350 (signaling exchange 504). The transmission may be sent, for example, via a broadcast message using a control channel, sent directly to the STA 350 using a dedicated or shared control channel or data channel, and so on.

At some later time, the STA 350 may utilize the obtained 3G/4G cellular RAT information to perform certain processing, such as in conjunction with a cell reselection procedure, to determine whether there is a more preferable system in its operating environment to which it may connect or otherwise be handed over (processing block 506). For example, if the WLAN AP 310 is operating in a 20 MHz bandwidth only, but the STA 350 is informed that the femto base station 330 is operating (e.g., in CA mode) with a 40 MHz bandwidth, the STA 350 may decide to receive service from the femto base station 330 instead of the WLAN AP 310. When a connection or other handover decision is made, the STA 350 may initiate a connection establishment procedure to establish a connection with the femto base station 330 (block 508).

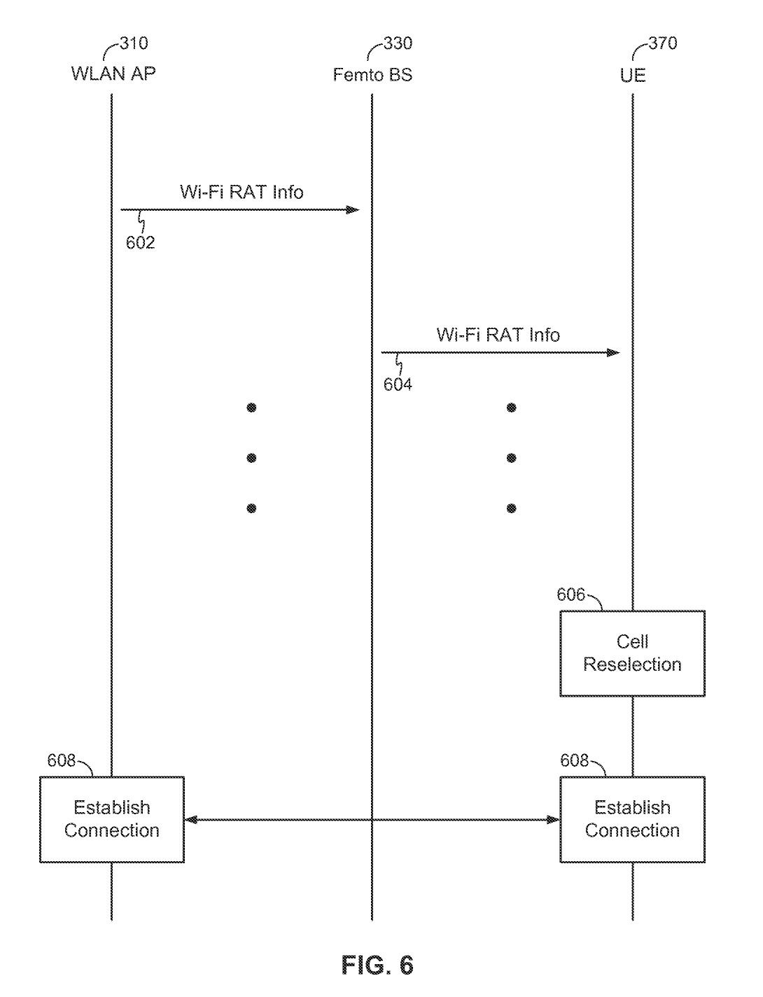

FIG. 6 is a signaling flow diagram illustrating another example method of providing inter-RAT information in a wireless communication network. Again, for generality, the following description of inter-RAT advertising and related aspects is provided in the context of the WLAN AP 310 and femto base station 330 design of FIG. 3. It will be appreciated, however, that this description applies equally to other designs involving a different arrangement of a first base station operating in accordance with a first RAT and a second base station operating in accordance with a different second RAT, such as the co-located WLAN AP module 420 and FM 430 design of FIG. 4 or still other designs.

In this example, the femto base station 330 provides one of the UEs 370 with inter-RAT information relating to the WLAN AP 310, which the UE 370 uses to perform cell reselection and connect to the WLAN AP 310.

In particular, the femto base station 330 initially obtains information relating to the Wi-Fi RAT implemented by the WLAN AP 310 operating in its vicinity (signaling exchange 602). This information may relate to various device capabilities, system configurations, or system parameters for the Wi-Fi RAT, and may be determined in different ways by the WLAN AP module 420, such as via over-the-air sniffing or backhaul-based information exchange (as shown), or by user device messaging and so on. The femto base station 330 subsequently transmits all or a portion of the obtained information to the UE 370 (signaling exchange 604). The transmission may be sent, for example, via a broadcast message using a control channel, sent directly to the UE 370 using a dedicated or shared control channel or data channel, and so on.

At some later time, the UE 370 may utilize the obtained Wi-Fi RAT information to perform certain processing, such as in conjunction with a cell reselection procedure, to determine whether there is a more preferable system in its operating environment to which it may connect or otherwise be handed over (processing block 606). For example, the UE 370 may support Wi-Fi but only 802.11n Wi-Fi would provide faster data rates than the 3G/4G cellular service provided by the femto base station 330. Thus, if the UE 370 is informed that the WLAN AP 310 supports an 802.11n operating mode, the UE 370 may determine that it can safely transition to Wi-Fi service for faster data rates, if needed. When a connection or other handover decision is made, the UE 370 may initiate a connection establishment procedure to establish a connection with the WLAN AP 310 (block 608).

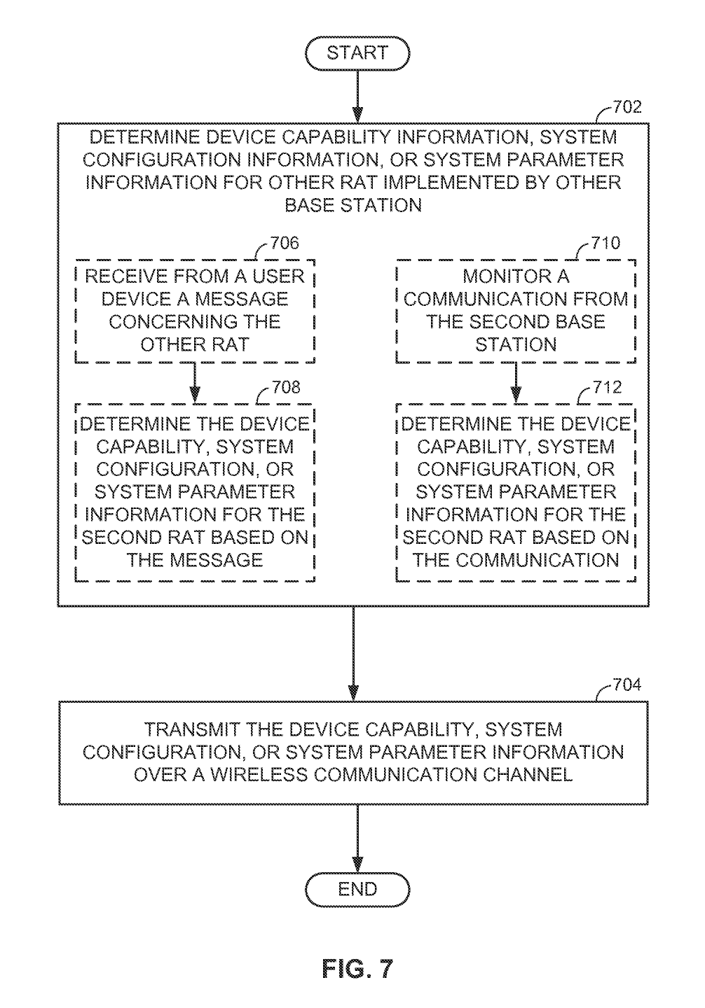

FIG. 7 is a flow diagram illustrating an example method for a base station of providing inter-RAT information in a wireless communication network. As discussed above, the base station providing the inter-RAT information may be a first base station (e.g., one of the WLAN AP 310 or femto base station 330) operating in accordance with a first RAT (e.g., one of a Wi-Fi RAT or 3G/4G cellular RAT) and the inter-RAT information may concern a second base station (e.g., the other of the WLAN AP 310 or femto base station 330) operating in accordance with a different second RAT (e.g., the other of the Wi-Fi or 3G/4G cellular RAT).

As shown, the first base station, operating in accordance with its first RAT, may determine device capability information, system configuration information, or system parameter information for the second RAT (different from the first RAT) that is implemented by the second base station (different from the first base station) (block 702). The first base station may then transmit the device capability, system configuration, or system parameter information for the second RAT over a wireless communication channel on the first RAT (block 704).

As discussed in more detail above, the device capability information may comprise, for example, at least one of a multiple-input, multiple-output capability or carrier aggregation capability of the second base station. The system configuration information may comprise, for example, at least one of a supported mode of operation or a bandwidth utilization of the second base station. The system parameter information may comprise, for example, at least one of a signal acquisition timing or a scrambling code utilized by the second base station. According to different system designs, the first base station and the second base station may be, for example, remotely located from one another as in the design of FIG. 3, or physically or logically co-located as in the design of FIG. 4, while still remaining distinct.

Returning to FIG. 7, determining the device capability, system configuration, or system parameter information for the second RAT may be performed in a variety of ways. For example, the first base station may receive from a user device (e.g., one in communication with the first base station) a message concerning the second RAT (optional block 706) and determine the device capability, system configuration, or system parameter information for the second RAT based on the message from the user device (optional block 708). As another example, the first base station may monitor a communication from the second base station (optional block 710) and determine the device capability, system configuration, or system parameter information for the second RAT based on the communication from the second base station (optional block 712).

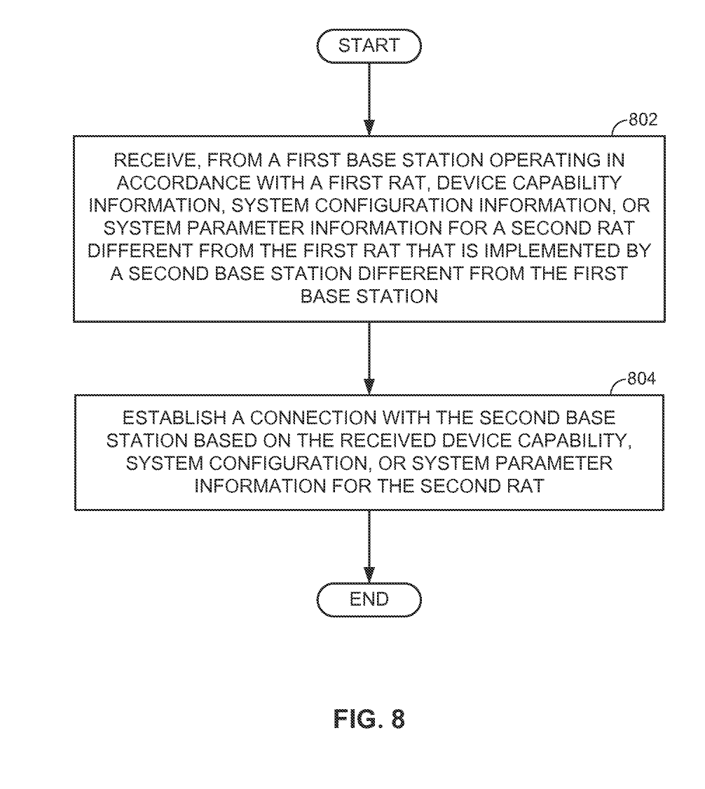

FIG. 8 is a flow diagram illustrating an example method for a user device of utilizing inter-RAT information in a wireless communication network. As discussed above, the user device receiving the inter-RAT information may be, for example, one of the STAs 350 in communication with the WLAN AP 310 operating in accordance with a first RAT (e.g., a Wi-Fi RAT) or one of the UEs 370 in communication with the femto base station 330 operating in accordance with a different second RAT (e.g., a 3G/4G cellular RAT).

As shown, the user device may receive, from a first base station operating in accordance with a first RAT, device capability information, system configuration information, or system parameter information for a second RAT different from the first RAT that is implemented by a second base station different from the first base station (block 802). The user device may subsequently establish a connection with the second base station based on the received device capability, system configuration, or system parameter information for the second RAT (block 804).

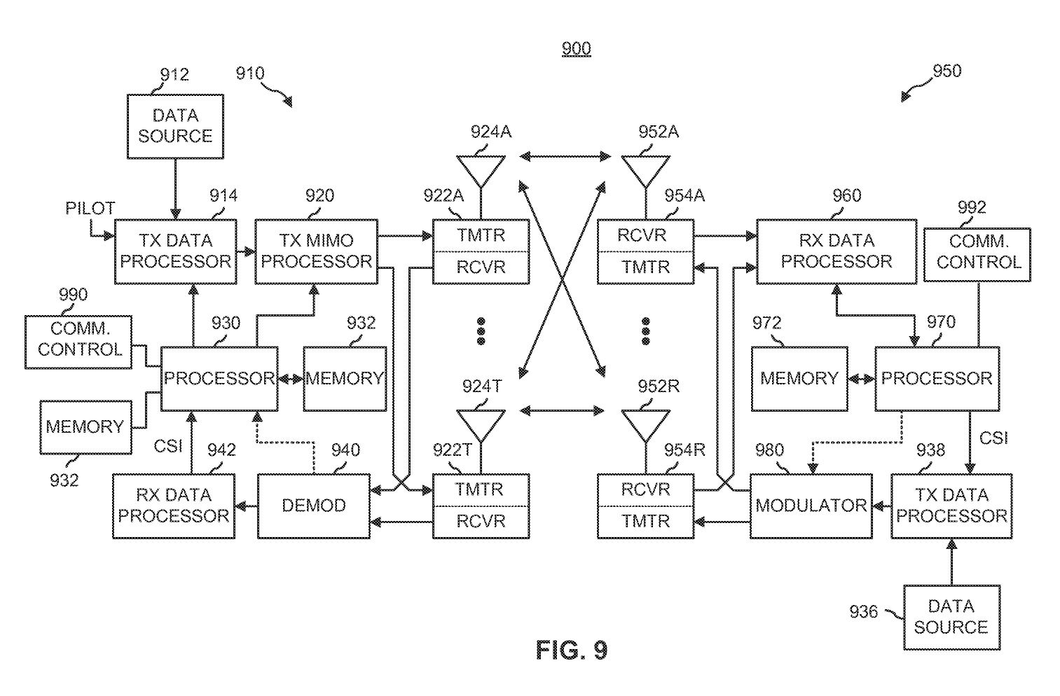

FIG. 9 illustrates in more detail the principles of wireless communication between a wireless device 910 (e.g., a base station) and a wireless device 950 (e.g., a user device) of a sample communication system 900. At the device 910, traffic data for a number of data streams is provided from a data source 912 to a transmit (TX) data processor 914. Each data stream may then be transmitted over a respective transmit antenna.

The TX data processor 914 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides NT modulation symbol streams to NT transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 922A through 922T are then transmitted from NT antennas 924A through 924T, respectively.

At the device 950, the transmitted modulated signals are received by NR antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the NR received symbol streams from NR transceivers 954 based on a particular receiver processing technique to provide NT “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which pre-coding matrix to use for determining the beam-forming weights then processes the extracted message.

FIG. 9 also illustrates that the communication components may include one or more components that perform inter-RAT advertising operations as taught herein. For example, a communication (COMM.) component 990 may cooperate with the processor 930 and/or other components of the device 910 to advertise or otherwise provide inter-RAT information as taught herein. Similarly, a communication control component 992 may cooperate with the processor 970 and/or other components of the device 950 to support inter-RAT advertising as taught herein. It should be appreciated that for each device 910 and 950 the functionality of two or more of the described components may be provided by a single component. For example, a single processing component may provide the functionality of the communication control component 990 and the processor 930 and a single processing component may provide the functionality of the communication control component 992 and the processor 970.

The functionality described herein (e.g., with regard to one or more of the accompanying figures) may correspond in some aspects to similarly designated “means for” functionality in the appended claims.

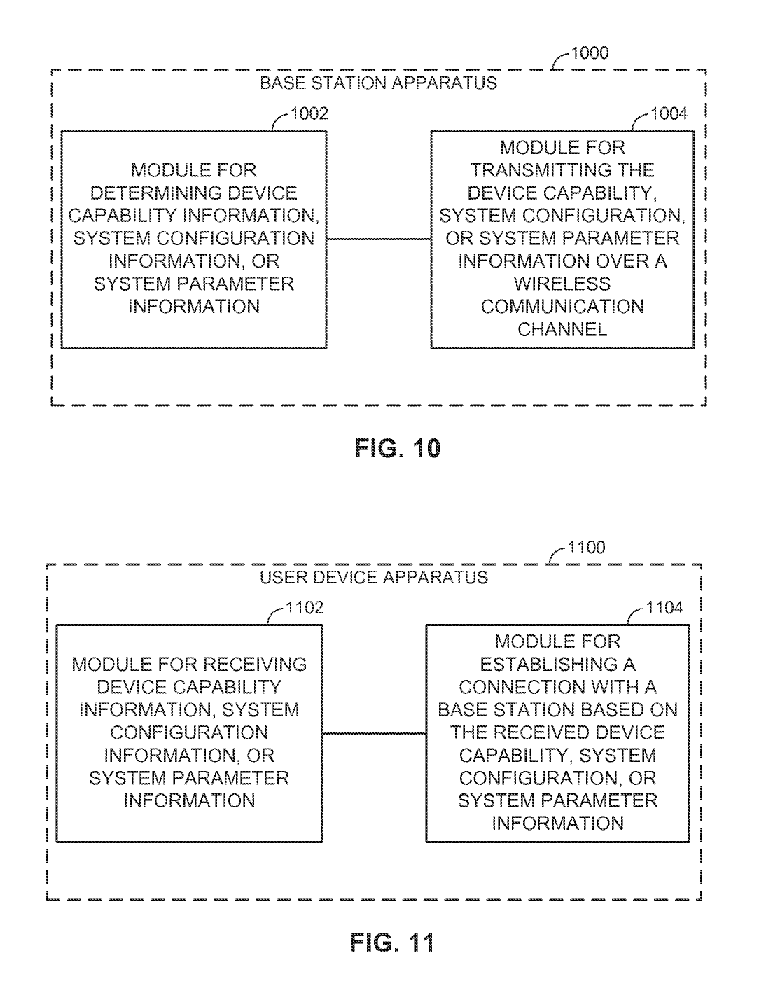

FIG. 10 illustrates an example base station apparatus 1000 represented as a series of interrelated functional modules. A module for determining 1004 may correspond at least in some aspects to, for example, a processing system as discussed herein. A module for transmitting 1004 may correspond at least in some aspects to, for example, a communication device (e.g., a transmitter) as discussed herein.

FIG. 11 illustrates an example user device apparatus 1100 represented as a series of interrelated functional modules. A module for receiving 1102 may correspond at least in some aspects to, for example, a communication device (e.g., a receiver) as discussed herein. A module for establishing a connection with a base station 1104 may correspond at least in some aspects to, for example, a communication device (e.g., a transceiver) in conjunction with a processing system as discussed herein.

The functionality of the modules of FIGS. 10 and 11 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1000 may comprise a single device (e.g., components 1002-1004 comprising different sections of an ASIC). As another specific example, the apparatus 1000 may comprise several devices (e.g., the component 1002 comprising one ASIC and the component 1004 comprising another ASIC). The functionality of these modules also may be implemented in some other manner as taught herein.

In addition, the components and functions represented by FIGS. 10 and 11 as well as other components and functions described herein, may be implemented using any suitable means. Such means also may be implemented, at least in part, using corresponding structure as taught herein. For example, the components described above in conjunction with the “module for” components of FIGS. 10 and 11 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for providing inter-RAT information in a wireless communication network. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of providing inter-radio access technology (RAT) information in a wireless communication network, comprising:
determining, at a first base station operating in accordance with a first RAT, device capability information, system configuration information, or system parameter information for a second RAT different from the first RAT that is implemented by a second base station different from the first base station; and
transmitting by the first base station the device capability, system configuration, or system parameter information for the second RAT over a wireless communication channel on the first RAT.

2. The method of claim 1, wherein the device capability information comprises at least one of a multiple-input, multiple-output capability or carrier aggregation capability of the second base station.

3. The method of claim 1, wherein the system configuration information comprises at least one of a supported mode of operation or a bandwidth utilization of the second base station.

4. The method of claim 1, wherein the system parameter information comprises at least one of a signal acquisition timing or a scrambling code utilized by the second base station.

5. The method of claim 1, wherein the first base station and the second base station are remotely located from one another.

6. The method of claim 1, wherein the first base station and the second base station are physically or logically co-located.

7. The method of claim 1, wherein the first base station is one of a femto base station operating according to a cellular communication RAT or a wireless local area network access point operating according to an IEEE 802.11 RAT, and wherein the second base station is the other of the femto base station operating according to a cellular communication RAT or the wireless local area network access point operating according to an IEEE 802.11 RAT.

8. The method of claim 1, wherein determining the device capability, system configuration, or system parameter information for the second RAT comprises:
receiving, by the first base station from a user device in communication with the first base station, a message concerning the second RAT; and
determining the device capability, system configuration, or system parameter information for the second RAT based on the message from the user device.

9. The method of claim 1, wherein determining the device capability, system configuration, or system parameter information for the second RAT comprises:
monitoring, by the first base station, a communication from the second base station; and
determining the device capability, system configuration, or system parameter information for the second RAT based on the communication from the second base station.

10. An apparatus for providing inter-radio access technology (RAT) information in a wireless communication network, comprising:
at least one processor configured to:
determine, at a first base station operating in accordance with a first RAT, device capability information, system configuration information, or system parameter information for a second RAT different from the first RAT that is implemented by a second base station different from the first base station, and
transmit by the first base station the device capability, system configuration, or system parameter information for the second RAT over a wireless communication channel on the first RAT; and
memory coupled to the at least one processor.

11. The apparatus of claim 10, wherein the device capability information comprises at least one of a multiple-input, multiple-output capability or carrier aggregation capability of the second base station.

12. The apparatus of claim 10, wherein the system configuration information comprises at least one of a supported mode of operation or a bandwidth utilization of the second base station.

13. The apparatus of claim 10, wherein the system parameter information comprises at least one of a signal acquisition timing or a scrambling code utilized by the second base station.

14. The apparatus of claim 10, wherein the first base station and the second base station are remotely located from one another.

15. The apparatus of claim 10, wherein the first base station and the second base station are physically or logically co-located.

16. The apparatus of claim 10, wherein the first base station is one of a femto base station operating according to a cellular communication RAT or a wireless local area network access point operating according to an IEEE 802.11 RAT, and wherein the second base station is the other of the femto base station operating according to a cellular communication RAT or the wireless local area network access point operating according to an IEEE 802.11 RAT.

17. The apparatus of claim 10, wherein the at least one processor is configured to determine the device capability, system configuration, or system parameter information for the second RAT by being configured to:
receive, by the first base station from a user device in communication with the first base station, a message concerning the second RAT; and
determine the device capability, system configuration, or system parameter information for the second RAT based on the message from the user device.

18. The apparatus of claim 10, wherein the at least one processor is configured to determine the device capability, system configuration, or system parameter information for the second RAT by being configured to:
monitor, by the first base station, a communication from the second base station; and
determine the device capability, system configuration, or system parameter information for the second RAT based on the communication from the second base station.

19. An apparatus for providing inter-radio access technology (RAT) information in a wireless communication network, comprising:
means for determining, at a first base station operating in accordance with a first RAT, device capability information, system configuration information, or system parameter information for a second RAT different from the first RAT that is implemented by a second base station different from the first base station; and
means for transmitting by the first base station the device capability, system configuration, or system parameter information for the second RAT over a wireless communication channel on the first RAT.

20. The apparatus of claim 19, wherein the device capability information comprises at least one of a multiple-input, multiple-output capability or carrier aggregation capability of the second base station, wherein the system configuration information comprises at least one of a supported mode of operation or a bandwidth utilization of the second base station, and wherein the system parameter information comprises at least one of a signal acquisition timing or a scrambling code utilized by the second base station.

21. The apparatus of claim 19, wherein the first base station and the second base station are physically or logically co-located.

22. The apparatus of claim 19, wherein the first base station is one of a femto base station operating according to a cellular communication RAT or a wireless local area network access point operating according to an IEEE 802.11 RAT, and wherein the second base station is the other of the femto base station operating according to a cellular communication RAT or the wireless local area network access point operating according to an IEEE 802.11 RAT.

23. The apparatus of claim 19, wherein the means for determining the device capability, system configuration, or system parameter information for the second RAT comprises:
means for receiving, by the first base station from a user device in communication with the first base station, a message concerning the second RAT; and
means for determining the device capability, system configuration, or system parameter information for the second RAT based on the message from the user device.

24. The apparatus of claim 19, wherein the means for determining the device capability, system configuration, or system parameter information for the second RAT comprises:
means for monitoring, by the first base station, a communication from the second base station; and
means for determining the device capability, system configuration, or system parameter information for the second RAT based on the communication from the second base station.

25. A non-transitory computer-readable medium comprising code, which, when executed by at least one processor, causes the at least one processor to perform operations for providing inter-radio access technology (RAT) information in a wireless communication network, the non-transitory computer-readable medium comprising:
code for determining, at a first base station operating in accordance with a first RAT, device capability information, system configuration information, or system parameter information for a second RAT different from the first RAT that is implemented by a second base station different from the first base station; and
code for transmitting by the first base station the device capability, system configuration, or system parameter information for the second RAT over a wireless communication channel on the first RAT.

26. The non-transitory computer-readable medium of claim 25, wherein the device capability information comprises at least one of a multiple-input, multiple-output capability or carrier aggregation capability of the second base station, wherein the system configuration information comprises at least one of a supported mode of operation or a bandwidth utilization of the second base station, and wherein the system parameter information comprises at least one of a signal acquisition timing or a scrambling code utilized by the second base station.

27. The non-transitory computer-readable medium of claim 25, wherein the first base station and the second base station are physically or logically co-located.

28. The non-transitory computer-readable medium of claim 25, wherein the first base station is one of a femto base station operating according to a cellular communication RAT or a wireless local area network access point operating according to an IEEE 802.11 RAT, and wherein the second base station is the other of the femto base station operating according to a cellular communication RAT or the wireless local area network access point operating according to an IEEE 802.11 RAT.

29. The non-transitory computer-readable medium of claim 25, wherein the code for determining the device capability, system configuration, or system parameter information for the second RAT comprises:
code for receiving, by the first base station from a user device in communication with the first base station, a message concerning the second RAT; and
code for determining the device capability, system configuration, or system parameter information for the second RAT based on the message from the user device.

30. The non-transitory computer-readable medium of claim 25, wherein the code for determining the device capability, system configuration, or system parameter information for the second RAT comprises:
code for monitoring, by the first base station, a communication from the second base station; and
code for determining the device capability, system configuration, or system parameter information for the second RAT based on the communication from the second base station.
